(19) United States
(12) Patent Application Publication
(10) Pub. No.: US 2022/0269752 A1
(43) Pub. Date: Aug. 25, 2022

(54) EXECUTION METHOD FOR CONVOLUTION COMPUTATION

(71) Applicant: NATIONAL CHENG KUNG UNIVERSITY, Tainan (TW)

(72) Inventors: Chung-ho Chen, Tainan (TW); Ting-jia WU, Tainan (TW); Cheng-chih HSIAO, Tainan (TW); Hsiang-yu WANG, Tainan (TW); Han-qun Huang, Tainan (TW)

(73) Assignee: NATIONAL CHENG KUNG UNIVERSITY, Tainan (TW)

(21) Appl. No.: 17/668,395

(22) Filed: Feb. 10, 2022

Related U.S. Application Data
(60) Provisional application No. 63/147,804, filed on Feb. 10, 2021.

(51) Int. Cl. G06F 17/15; G06F 7/544

(52) U.S. Cl. CPC G06F 17/15; G06F 7/5443

(57) ABSTRACT

An execution method for convolution computation is disclosed, which includes: dividing an input image of N channels into a first tile to an X-th tile according to a feature tile; sequentially performing convolution computations on the data in the first tile to the X-th tile of the input image of the N channels, and storing the computation results as output data; mapping the data in each of the tiles by a kernel, and performing multiply-accumulate operations on the mapped data in each of the tiles, wherein each time the multiply-accumulate operation performed on the data mapped by the kernel is complete, the kernel is shifted to change the mapped data in said tile, and multiply-accumulate operation is performed on the changed mapped data until the multiply-accumulate operations performed on all of the data in said tile are complete, thereby finishing the convolution computation of said tile.

### CROSS REFERENCE TO RELATED APPLICATIONS

The present disclosure claims priority to U.S. Provisional Patent Application, Ser. No. 63/147,804, filed on Feb. 10, 2021. The U.S. Provisional patent applications are hereby incorporated by reference in their entireties.

### FIELD OF INVENTION

The present disclosure relates to the field of an execution method for convolution computation, and more particularly, to an execution method for convolution computation that reuses data.

### BACKGROUND OF INVENTION

A convolutional neural network (CNN) is a type of deep neural network, which uses a convolution layer to filter inputs to obtain useful information. The filter of the convolution layer can be modified according to the learned parameters to extract the most useful information of a specific work. Convolutional neural networks are generally applicable to classification, detection, and recognition, such as image classification, medical image analysis, and image/video recognition.

At present, there are many neural network accelerators, such as Eyeriss, Tensor Processing Unit (TPU), DianNao family, Angel-Eye, and EIE. However, some accelerators, TPU, DaDianNao, and EIE are not suitable for low-end edge devices because either large on-chip memory or significant off-chip memory access is required. Eyeriss and Angel-Eye support multiple dimensional size filers, but either the processing unit architecture design or the filter mapping on MACs results in low utilization rate of multiply-accumulate units (MACs).

### SUMMARY OF INVENTION

In view of the aforementioned problem, the present disclosure provides an execution method for convolution computation. During the execution, the data of some input images, weight values, and output images are reused to avoid repeated access to the same data from off-chip memory or on-chip memory, thereby improving the efficiency.

An aspect of the present disclosure is to disclose an execution method for convolution computation, which is executed by a convolution computation unit that includes a plurality of processing units and a controller. An input image of N channels is divided into X tiles including a first tile to an X-th tile according to a feature tile with size of T×T by the controller, wherein each of the X tiles includes T×T data, which are Iⱼ(1,1)-Iⱼ(T, T), wherein j is corresponding one of the channels and 1≤j≤N. Convolution computations are sequentially performed on the data in the first tile of the input image of the N channels to the X-th tile of the input image of the N channels by the processing units, and the computation results are stored as output data. The data in each of the tiles are mapped by a kernel with size of A×A, and multiply-accumulate operation is performed on the mapped data in each of the tiles. Each time one of the multiply-accumulate operations performed on the A×A data mapped by the kernel is complete, the kernel is shifted to change the mapped data in said tile, and multiply-accumulate operation is performed on the changed mapped data until the multiply-accumulate operations performed on all of the data in said tile are complete, thereby finishing the convolution computation of said tile. All of the output data form an output image, wherein 1≤A≤T.

In some embodiments of the present disclosure, in the condition of A=3, the mapped data in each of the tiles for the multiply-accumulate operations are Iⱼ(p, q), Iⱼ((p+1), q), Iⱼ((p+2), q), Iⱼ(p, (q+1)), Iⱼ((p+1), (q+1)), Iⱼ((p+2), (q+1)), Iⱼ(p, (q+2)), Iⱼ(p+1), (q+2)), Iⱼ((p+2), (q+2)), wherein 1≤p≤(T−2), 1≤q≤(T−2); wherein when p=1 and q=1, a first multiply-accumulate operation is performed.

In some embodiments of the present disclosure, when p≠(T−2), each time one of the multiply-accumulate operations performed on the A×A data mapped by the kernel is complete, the kernel is shifted so that p is added by 1 until p=(T−2).

In some embodiments of the present disclosure, when p=(T−2) and q=K, after the multiply-accumulate operation performed on the mapped data, which are Iⱼ((T−2), K), Iⱼ((T−1), K), Iⱼ(T, K), Iⱼ((T−2), (K+1)), Iⱼ((T−1), (K+1)), Iⱼ(T, (K+1)), Iⱼ((T−2), (K+2)), Iⱼ((T−1), (K+2)), Iⱼ(T, (K+2)), is complete, the kernel is shifted so that p=1 and q=(K+1), wherein 1≤K≤(T−2).

In some embodiments of the present disclosure, when p=(T−2) and q=(T−2), after the multiply-accumulate operation performed on the mapped data, which are Iⱼ((T−2), (T−2)), Iⱼ((T−1), (T−2)), Iⱼ(T, (T−2)), Iⱼ((T−2), (T−1)), Iⱼ((T−1), (T−1)), Iⱼ(T, (T−1)), Iⱼ((T−2), T), Iⱼ((T−1), T), Iⱼ(T, T), is complete, the multiply-accumulate operations performed on all of the data in said tile are complete, and the kernel is not shifted.

In some embodiments of the present disclosure, a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

In some embodiments of the present disclosure, each of the processing units includes Y multiply-accumulate units for performing the multiply-accumulate operation. In the condition of A=5 and Y<25, the mapped data of each of the tiles for the multiply-accumulate operations are twenty-five data Iⱼ(p, q)-Iⱼ((p+4), (q+4)), wherein 1≤p≤(T−4), 1≤q≤(T−4); when p≠(T−4), the multiply-accumulate operation is performed on the consecutive mapped data from the first to the Y-th among the twenty-five mapped data, wherein after the multiply-accumulate operation performed on the consecutive mapped data from the first to the Y-th are complete, the kernel is shifted so that p is added by 1, and the multiply-accumulate operation are performed on the changed consecutive mapped data from the first to the Y-th among the twenty-five mapped data until p=(T−4).

In some embodiments of the present disclosure, when p=(T−4) and q=K, after the multiply-accumulate operation performed on the consecutive mapped data from the first to the Y-th among the twenty-five mapped data are complete, the kernel is shifted so that p=1 and q=(K+1), and the multiply-accumulate operation are performed on the changed consecutive mapped data from the first to the Y-th among the twenty-five mapped data, wherein 1≤K≤(T−4).

In some embodiments of the present disclosure, when p=(T−4) and q=(T−4), after the multiply-accumulate operation performed on the consecutive mapped data from the first to the Y-th among the twenty-five mapped data are complete, the kernel is shifted so that p=1 and q=1 in the condition of (25−Y)>Y, and each time the kernel is shifted, the multiply-accumulate operation is performed on the changed consecutive mapped data from the (Y+1)-th to the 2Y-th among the twenty-five mapped data.

In some embodiments of the present disclosure, when p=(T−4) and q=(T−4), after the multiply-accumulate operation performed on the consecutive mapped data from the first to the Y-th among the twenty-five mapped data are complete, the kernel is shifted so that p=1 and q=1 in the condition of (25−Y)<Y, and each time the kernel is shifted, the multiply-accumulate operation is performed on the changed consecutive mapped data from the (Y+1)-th to the 25th among the twenty-five mapped data and Z default data from the first to the Z-th, wherein Z=(2Y−25).

In some embodiments of the present disclosure, a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

In some embodiments of the present disclosure, each of the processing units includes Y multiply-accumulate units for performing the multiply-accumulate operation, in the condition of A=1 and 1<Y<N, the mapped data for the multiply-accumulate operation are data, which are Iⱼ(p, q)-I_{Y}(p, q) at a same position of the input image from the first channel to the Y-th channel, wherein 1≤p≤T, 1≤q≤T.

In some embodiments of the present disclosure, when p≠T, each time one of the multiply-accumulate operations performed on the Y data mapped by the kernel is complete, the kernel is shifted so that p is added by 1 until p=T.

In some embodiments of the present disclosure, when p=T and q=K, after the multiply-accumulate operation performed on the Y mapped data, which are Iⱼ (T, K)-I_{Y}(T, K), is complete, the kernel is shifted so that p=1 and q=(K+1), wherein 1≤K≤(T−1).

In some embodiments of the present disclosure, when p=T and q=T, after the multiply-accumulate operation performed on the Y mapped data, which are Iⱼ (T, T)-I_{Y}(T, T), is complete, the kernel is shifted so that p=1 and q=1 in the condition of (N−Y)>Y, and the mapped data for the multiply-accumulate operation are data, which are I_{(Y+1)}(p, q)-I_{2Y}(p, q) at a same position of the input image from the (Y+1)-th channel to the 2Y-th channel.

In some embodiments of the present disclosure, when p=T and q=T, after the multiply-accumulate operation performed on the Y mapped data, which are Iⱼ (T, T)-I_{Y}(T, T), is complete, the kernel is shifted so that p=1 and q=1 in the condition of (N−Y)<Y, and the mapped data for the multiply-accumulate operation are data, which are I_{(Y+1)}(p, q)-I_{N}(p, q) at a same position of the input image from the (Y+1)-th channel to the N-th channel and F default data from the first to the F-th, wherein F=(2Y−N).

In some embodiments of the present disclosure, each time one of the multiply-accumulate operations performed on the data mapped by the kernel is complete, the completed multiply-accumulate operation result is added by a partial sum to obtain the computation result, and a value of the partial sum is replaced by a value of the computation result.

To sum up, in the execution method for convolution computation of the present disclosure, during the execution, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit is improved.

### DESCRIPTION OF DRAWINGS

FIG. 1 illustrates an architecture diagram of a convolution computation unit according to an embodiment of the present disclosure.

FIG. 2 is a flowchart of an execution method for convolution computation according to an embodiment of the present disclosure.

FIG. 3A to FIG. 3H illustrate schematic diagrams of steps of the execution method for convolution computation according to a first embodiment of the present disclosure.

FIG. 4A to FIG. 4F illustrate schematic diagrams of steps of the execution method for convolution computation according to a second embodiment of the present disclosure.

FIG. 5A to FIG. 5D illustrate schematic diagrams of steps of the execution method for convolution computation according to a third embodiment of the present disclosure

FIG. 6A illustrates an experimental result of performing the execution method for convolution computation on YOLOV3-tiny according to some embodiments of the present disclosure.

FIG. 6B illustrates an experimental result of performing the execution method for convolution computation on VGG16 according to some embodiments of the present disclosure.

FIG. 6C illustrates an experimental result of performing the execution method for convolution computation on AlexNet according to some embodiments of the present disclosure.

### DETAILED DESCRIPTION OF PREFERRED EMBODIMENTS

In order to make the aforementioned summary, other purposes, features and advantages of the present disclosure more obvious and easy to understand, the preferred embodiments of the present disclosure are described in detail below in combination with the attached drawings.

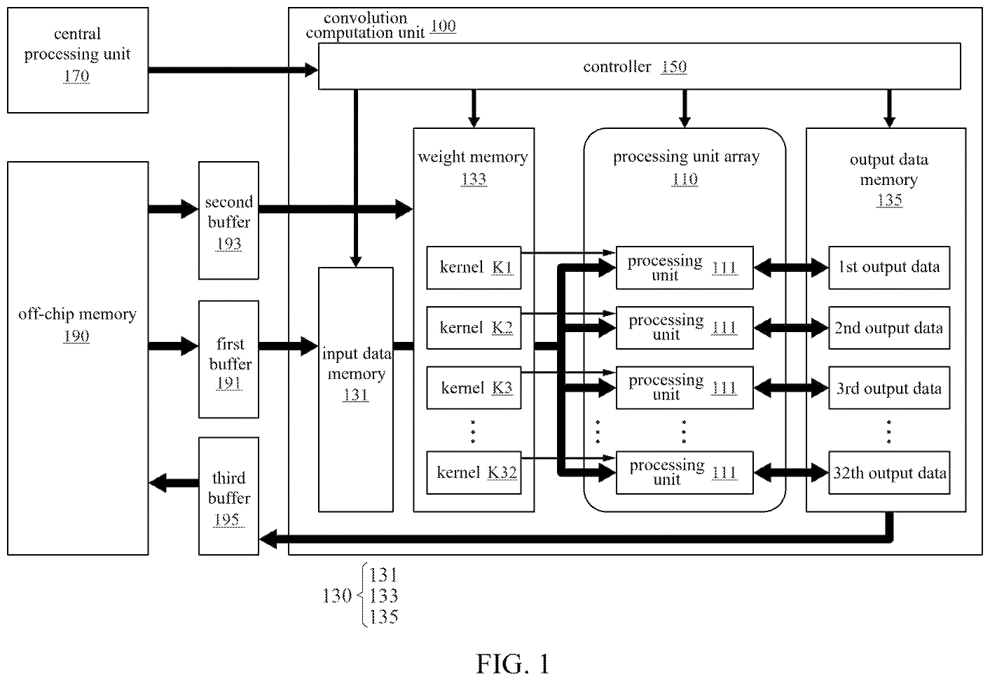

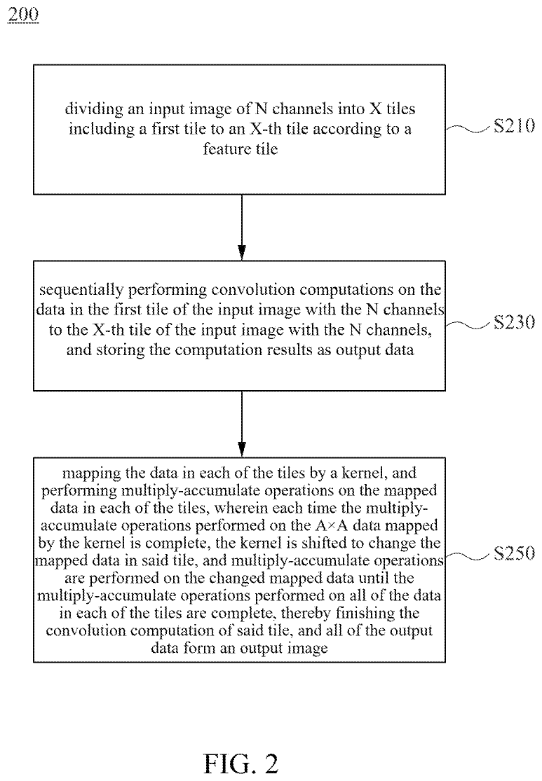

As shown in FIG. 1, FIG. 1 illustrates an architecture diagram of a convolution computation unit 100 according to an embodiment of the present disclosure. The convolution computation unit 100 may include a processing unit array 110, a memory unit 130, and a controller 150. The processing unit array 110 includes a plurality of one-dimensional processing units 111, which are respectively configured for performing convolution computation according to the instructions received by the controller 150 from a central processing unit 170, such as an execution method for convolution computation 200 shown in FIG. 2. In one embodiment, each of the processing units 111 includes a plurality of multiply-accumulate units (MAC) (not shown in the figure) to perform multiply-accumulate operations. The memory unit 130 is an on-chip memory, which includes an input data memory 131, a weight memory 133, and an output data memory 135. The input data memory 131 is configured for accessing the input data (e.g., an input image), which are stored in the off-chip memory 190 outside the convolution computation unit 100, required for convolution computation according to the instructions received by the controller 150 from a central processing unit 170. The weight memory 133 is configured for accessing the kernels K1-K32, which are stored in the off-chip memory 190 outside the convolution computation unit 100, required for convolution computation according to the instructions received by the controller 150 from a central processing unit 170, wherein the kernels include different numbers of weights based on different sizes. The output data memory 135 is configured for storing the computation results obtained after the convolution computation is performed by the processing unit array 110, i.e., the first output data to the 32th output data, which can form a corresponding output image.

In one embodiment, a first buffer 191, a second buffer 193, and a third buffer 195 are also provided between the convolution computation unit 100 and the off-chip memory 190. The input data required for convolution computation can be accessed and stored in the first buffer 191 previously by the first buffer 191, and the input data memory 131 can access these data directly from the first buffer 191. The kernels/weights required for convolution computation can be accessed and stored in the second buffer 193 previously by the second buffer 193, and the weight memory 133 can access these kernels/weights directly from the second buffer 191. The output data memory 135 can store the output image obtained by the convolution computation performed by the processing unit array 110 in the third buffer 195, and the third buffer 195 then stores these result data in the off-chip memory 190.

Reference is also made to FIG. 2. FIG. 2 is a flowchart of an execution method for convolution computation 200 according to an embodiment of the present disclosure. In the present embodiment, the execution method for convolution computation 200 is executed by the convolution computation unit 100. In this embodiment, the number of processing units 111 included in the processing unit array 110 may be 32, 32 convolution computations can be performed in parallel once, and 32 output data can be generated. Each of the processing units 111 may include 9 multiply-accumulate units. That is, the convolution computation unit 100 includes 288 multiply-accumulate units. The number of kernels is also 32 (e.g., K1-K32), which are corresponding to 32 processing units 111, respectively. Each of the kernels contains a different number of weights according to its size, and the weights in each of the kernels are not necessarily the same as each other.

In the execution method for convolution computation of the present disclosure, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit 100 is improved.

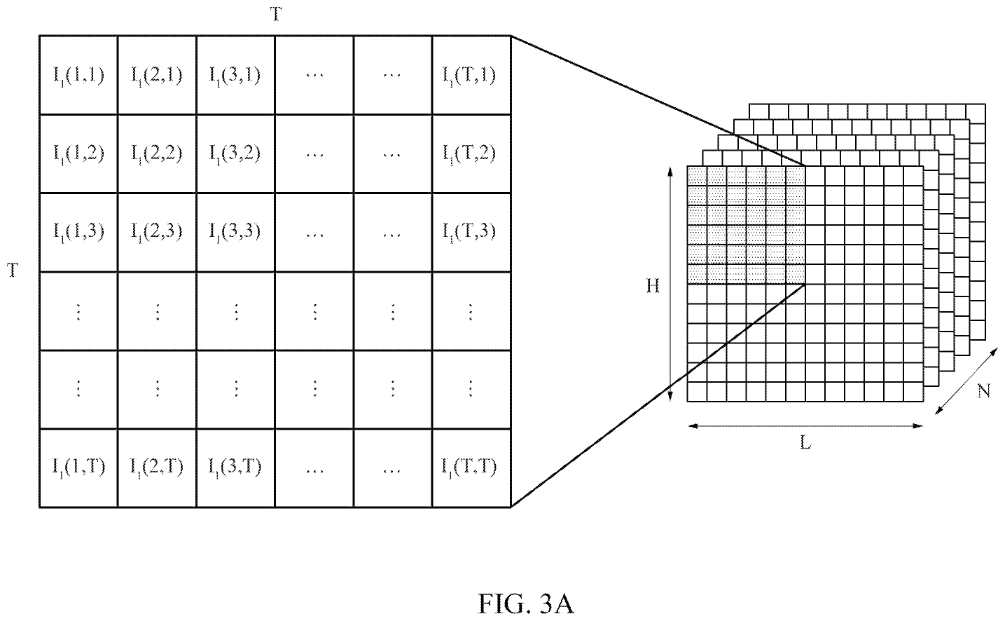

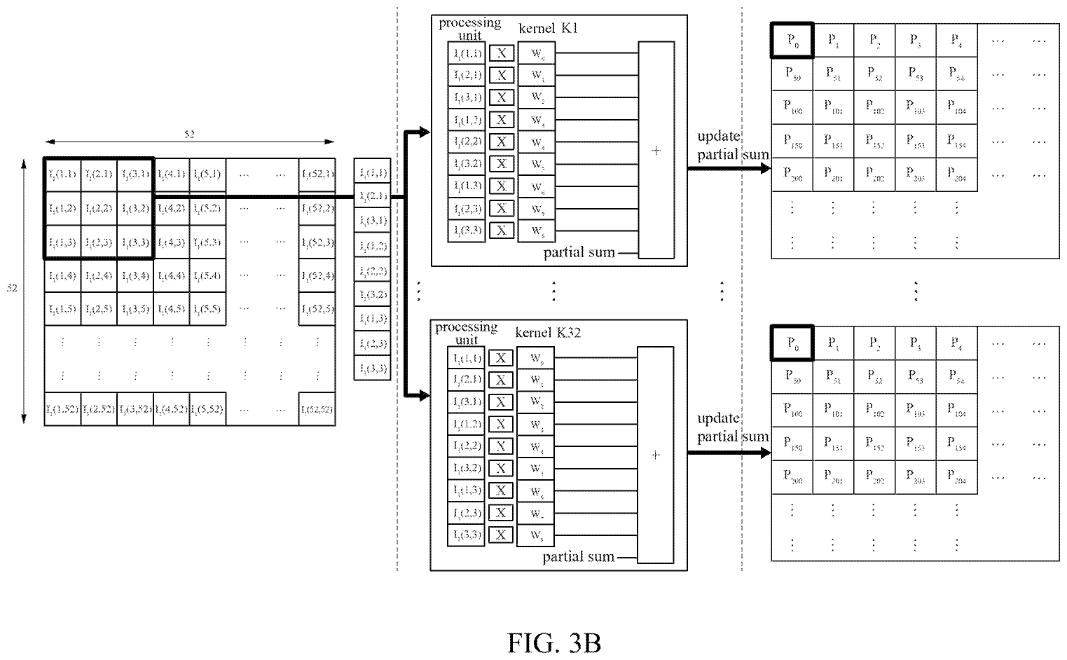

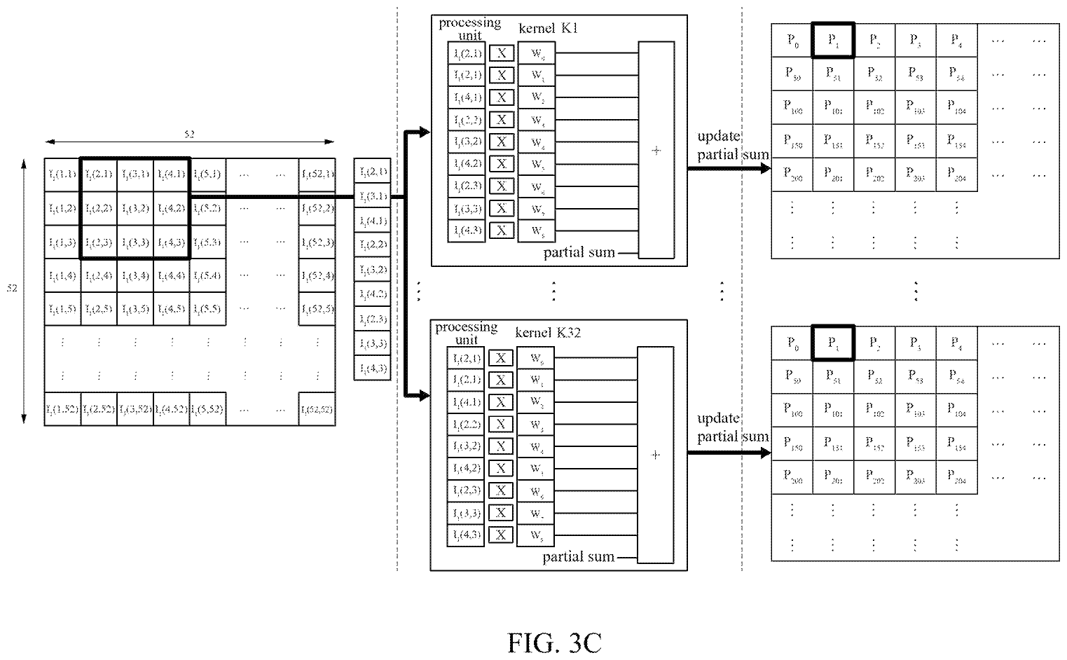

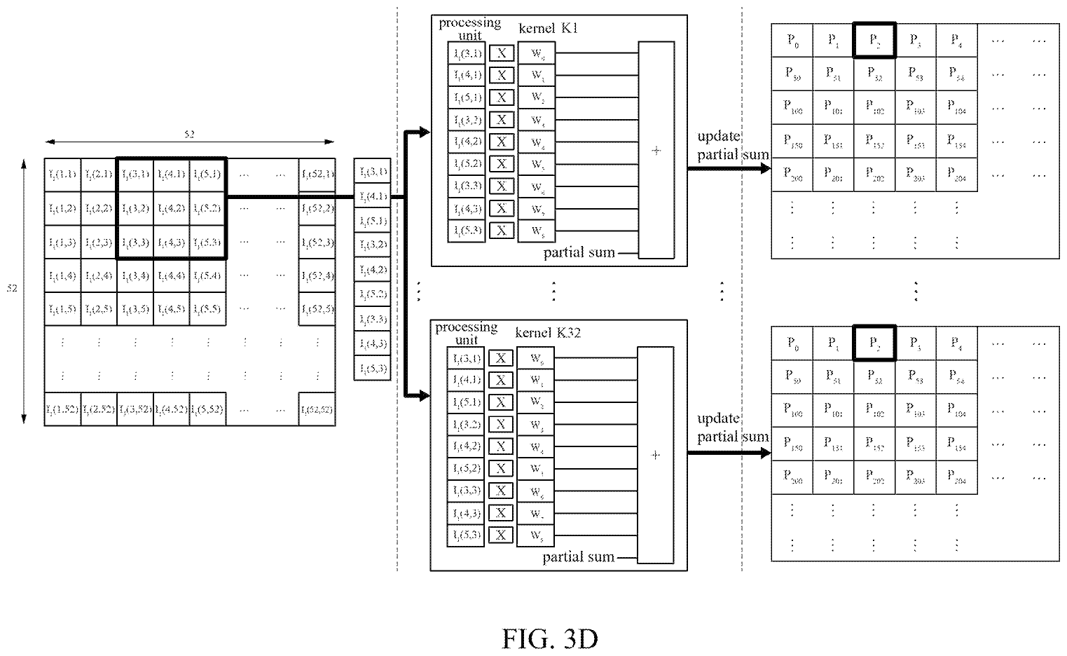

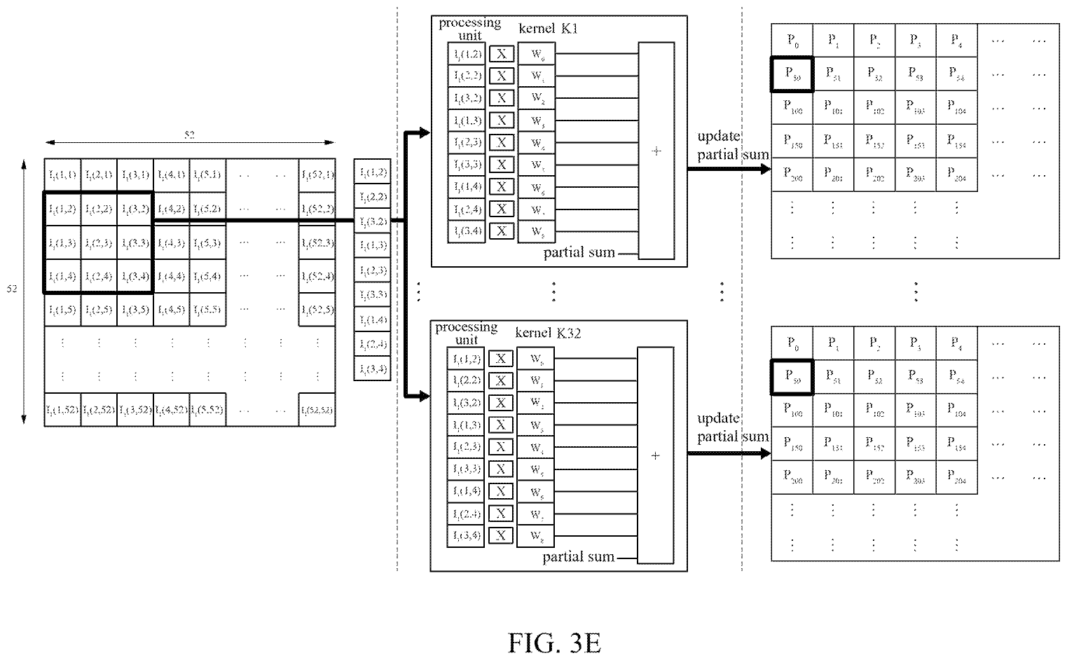

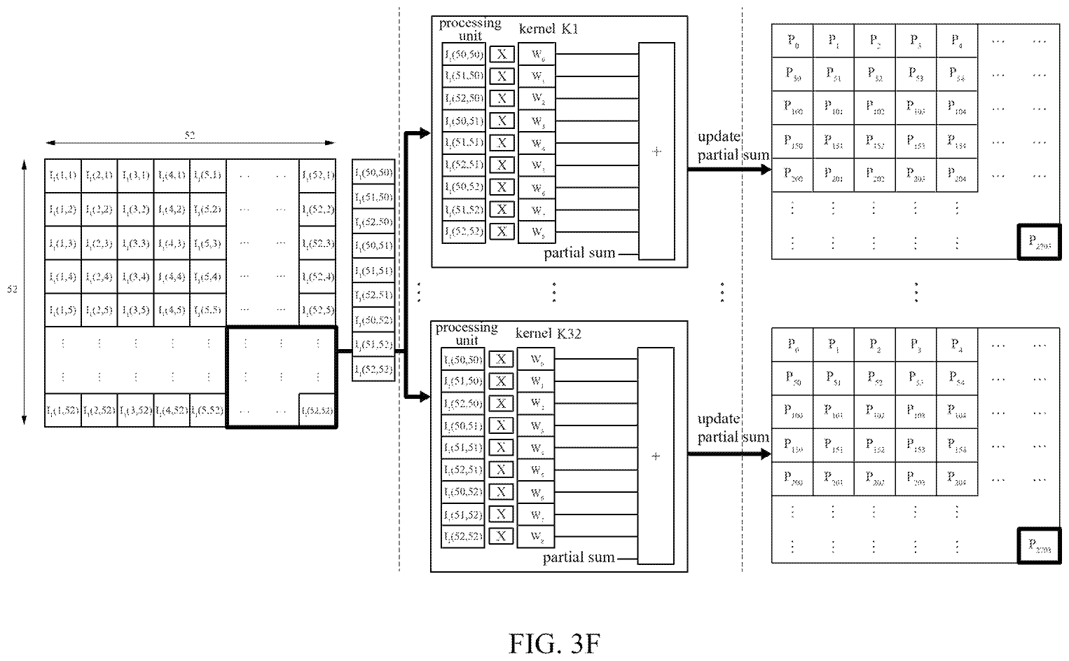

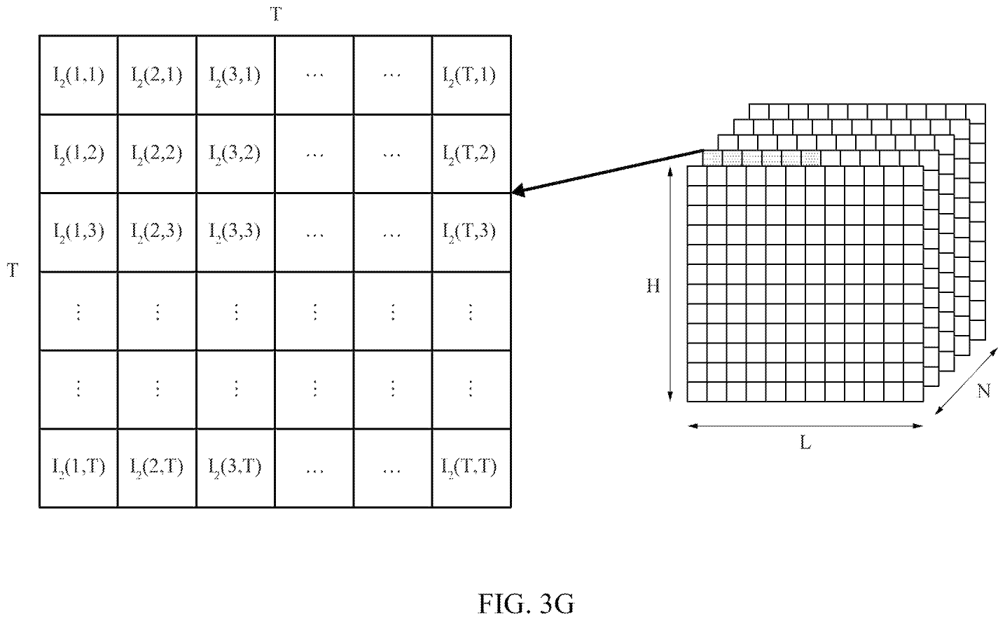

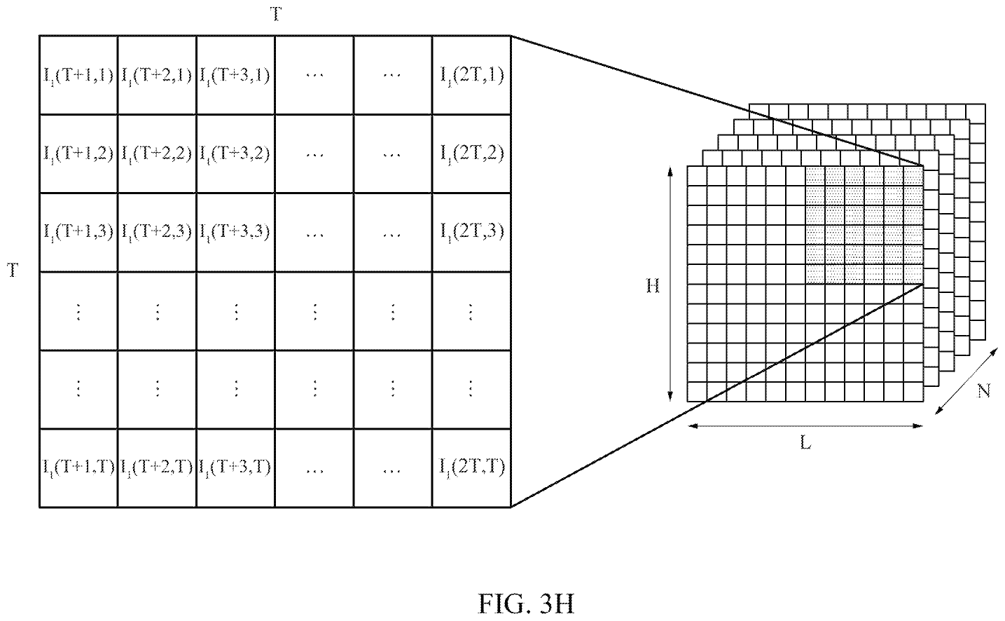

The execution method for convolution computation 200 includes steps S210 to S250. The details in the steps may be different according to the size of the kernel, which may be further described later. In step S210, an input image of N channels is divided into X tiles including a first tile to an X-th tile according to a feature tile with size of T×T by the controller 150, wherein each of the X tiles includes T×T data, which are Iⱼ(1,1)-Iⱼ(T, T), wherein j is corresponding one of the channels and 1≤j≤N (may refer to FIG. 3A). In step S230, convolution computations are sequentially performed on the data in the first tile of the input image of the N channels to the X-th tile of the input image of the N channels by the processing units 111, and the computation results are stored as output data. In step S250, the data in each of the tiles are mapped by a kernel with size of A×A, and multiply-accumulate operation is performed on the mapped data in each of the tiles. Each time one of the multiply-accumulate operations performed on the A×A data mapped by the kernel is complete, the kernel is shifted to change the mapped data in said tile, and multiply-accumulate operation is performed on the changed mapped data until the multiply-accumulate operations performed on all of the data in said tile are complete, thereby finishing the convolution computation of said tile. All of the output data form an output image, wherein 1≤A≤T.

References are also made to FIG. 3A-FIG. 3H. FIG. 3A to FIG. 3H illustrate schematic diagrams of steps of the execution method for convolution computation according to a first embodiment of the present disclosure. Since each processing unit 111 in the present embodiment includes 9 multiply-accumulate units, which can perform a set of multiply-accumulate operations for 3×3 kernel in parallel, the preferred size of the kernel is 3×3 (i.e., including 9 weights). Nevertheless, there are also optimization processes corresponding to other kernels with different sizes in the present disclosure, which may be further described later. Now, the kernel with the size of 3×3 is described in this embodiment first.

As shown in FIG. 3A, corresponding to step S210, the input image with the size of H×L×N is divided into multiple tiles according to the feature tile with the size of T×T, wherein H is the height of the input image, Lis the width of the input image, and N is the channel (or depth) of the input image. Therefore, the H×L input image of each channel (i.e., the first channel to the N-th channel) can be divided into the same number (e.g., X) of the tiles with the size of T×T. In this embodiment, the size of the feature tile is 52×52 (i.e., T=52).

Next, corresponding to step S230 and step S250, as shown in FIG. 3B to FIG. 3F. When the size of the input image is H×L×N, the input image of the first channel includes H×L data to be calculated, which are I₁ (1,1)-I₁ (L, H), and the input image of the N-th channel includes H×L data to be calculated, which are I_{N} (1,1)-I_{N} (L, H). Since the H×L×N input image is divided into multiple tiles according to the T×T feature tile previously, the first tile of each channel includes T×T data to be calculated, which are Iⱼ(1,1)-Iⱼ(T, T), wherein j is one of the channels and 1≤j≤N. Similarly, the second tile of each channel includes the data to be calculated from, which are Iⱼ(T+1,1)-Iⱼ(2T,2T), and so on.

In one embodiment, since the size of each of the input image may be different, a part of all tiles divided according to the feature tile with the size of T×T cannot include all of the data of the input image. Therefore, default data may be filled in the positions (or pixels) corresponding to the data of the input image not included in the divided tile. In one embodiment, the default data is zero.

For example, the input image with the size of 10×10 can include 100 input data iⱼ(1, 1)-iⱼ(10, 10). If the size of the feature block is 3×3, it can be divided into 16 blocks. The fourth tile only includes three data of the input image, which are iⱼ (10, 1), iⱼ(10, 2), iⱼ(10, 3), corresponding to the positions (1, 1), (1, 2), (1, 3) of the fourth tile, respectively. Besides, the data corresponding to the positions (2,1), (2,2), (2,3), (3,1), (3,2), (3,3) of the fourth tile are all zero. Similarly, the 16th tile only includes a datum of the input image iⱼ(10, 10) corresponding to the position (1, 1) of the 16th tile, and the data corresponding to the remaining positions of the 16th tile are all zero.

Next, as shown in FIG. 3B, the data in the tile are mapped by the kernel, and the multiply-accumulate operation is performed on the mapped data in said tile. In this embodiment, the size of the kernel is 3×3. Therefore, the mapped data can may be nine data, which are Iⱼ(p, q), Iⱼ((p+1), q), Iⱼ((p+2), q), Iⱼ(p, (q+1)), Iⱼ((p+1), (q+1)), Iⱼ ((p+2), (q+1)), Iⱼ(p, (q+2)), Iⱼ(p+1), (q+2)), Iⱼ((p+2), (q+2)), wherein 1≤p≤(T−2) and 1≤q≤(T−2). Generally, the first multiply-accumulate operation usually starts with the first data of the tile (i.e., iⱼ(1,1)) in order. Therefore, the first data mapped by the kernel in the first block can be I₁(1,1), I₁(2,1), I₁(3,1), I₁(1,2), I₁(2,2), I₁(3,2), I₁(1,3), I₁2,3), I₁(3,3), i.e., p=1 and q=1. These nine data may be transmitted to 32 processing units 111 in the processing unit array 110 for calculation. Each of the processing units 111 may use nine multiply-accumulate units to respectively multiply these nine data by the weights in the corresponding one of the kernels K1-K32 and then add them (i.e., the multiply-accumulate operation). In some embodiments, after the multiply-accumulate operation is complete, the processing unit 111 may further add the completed multiply-accumulate operation result by a partial sum Psum to obtain the computation result, store the computation result as the output data in the output data memory 135, and replace the value of the partial sum Psum by the value of the obtained computation result. In this embodiment, for the input image of the first channel, the corresponding first output result is as follows:

P₀=I₁(1,1)*W0+I₁(2,1)*W1+I₁(3,1)*W2+I₁(1,2)*W3+I₁(2,2)*W4+I₁(3,2)*W5+I₁(1,3)*W6+I₁(2,3)*W7+I₁(3,3)*W8+Psum

Since the partial sum Psum has not been calculated before, it is defaulted to 0. Since there are 32 processing units 111, the 9 data may be calculated at the same time and 32 first output data P₀ are obtained.

Next, as shown in FIG. 3C to FIG. 3D, when p≠(T−2), each time the multiply-accumulate operation is complete, the kernel is shifted so that p is added by 1 until p=(T−2). Specifically, the kernel is shifted right by one data unit in the first tile, such that the mapped data is shifted right by one unit. Then, the multiply-accumulate operation is performed on the changed nine mapped data. As shown in FIG. 3C, the nine mapped data now are I₁(2,1), I₁(3,1), I₁(4,1), I₁(2,2), I₁(3,2), I₁(4,2), I₁(2,3), I₁(3,3), I₁(4,3). Since the kernel is only shifted right by one data unit, some input data of this operation are the same as a portion of the input data of the previous operation. Hence, it is only necessary to access the new data (i.e., I₁(4,1), I₁(4,2) and I₁(4,3)). Moreover, these nine data are also transmitted to each of the processing unit 111 and are also calculated by the weight in the same kernel, and thus it is unnecessary to re-access the weights in the kernel. Similarly, the processing unit 111 adds the multiply-accumulate operation result of these nine data by the partial sum Psum (the previous computation result at this time), the obtained computation result is taken as the second output data P₁ of the output image of the first channel. Similarly the value of the partial sum Psum is replaced by the value of the present computation result. In other words, by updating the value of the partial sum Psum, the output data is also reused without accessing the previous computation result.

Next, as shown in FIG. 3E, when p=(T−2) and q=K, after the multiply-accumulate operation performed on the mapped data, which are Iⱼ((T−2), K), Iⱼ((T−1), K), Iⱼ(T, K), Iⱼ((T−2), (K+1)), Iⱼ((T−1), (K+1)), Iⱼ(T, (K+1)), Iⱼ((T−2), (K+2)), Iⱼ((T−1), (K+2)), Iⱼ(T, (K+2)), is complete, the kernel is shifted so that p=1 and q=(K+1), wherein 1≤K≤(T−2). Specifically, when the multiply-accumulate operations performed on the three rows of data of the tile mapped by the kernel (e.g., I₁(1,1)-I₁(T, 1), I₁(1,2)-I₁(T, 2), I₁(1,3)-I₁(T, 3)) are complete, the kernel is shifted to the data of the next row. That is, the kernel is shifted down by one data unit and return to the first column to the third column of the tile.

The kernel is shifted right or down according to the above rules until p=(T−2) and q=(T−2), as shown in FIG. 3F. At this time, the data mapped by the kernel is the last set of the data to be calculated in the first tile. Therefore, after the multiply-accumulate operation performed on the mapped data, which are Iⱼ((T−2), (T−2)), Iⱼ((T−1), (T−2)), Iⱼ(T, (T−2)), Iⱼ((T−2), (T−1)), Iⱼ((T−1), (T−1)), Iⱼ(T, (T−1)), Iⱼ((T−2), T), Iⱼ((T−1), T), Iⱼ(T, T), is complete, the multiply-accumulate operations performed on all of the data in said tile are complete. That is, the convolution computation performed on the first tile has finished, and thus the kernel is unnecessary to be shifted. At this time, the processing unit 111 can generate 2704th output data (in the case of T=52), and an output image can be formed according to all of the output data generated previously.

Next, as shown in FIG. 3G, after the convolution computation performed on the first tile of the input image of the first channel, the convolution computation is performed sequentially on the first tile of the input image of the second channel according to the above rules until the convolution computation performed on the first tile of the input image of the N-th channel is complete. After the convolution computations performed on the first tile of the input image of the N channels are complete, then it returns to the input image of the first channel, and the convolution computation is performed sequentially on the second tile of the input image of the first channel according to the above rules (as shown in FIG. 3H) until the convolution computations performed on all of the tiles of the input image of the N channels are complete.

Briefly, in the condition that the size of the kernel (i.e., the number of weights) is equal to the number of multiply-accumulate units included in each of processing units 111, a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

In the above method, during the execution, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit is improved.

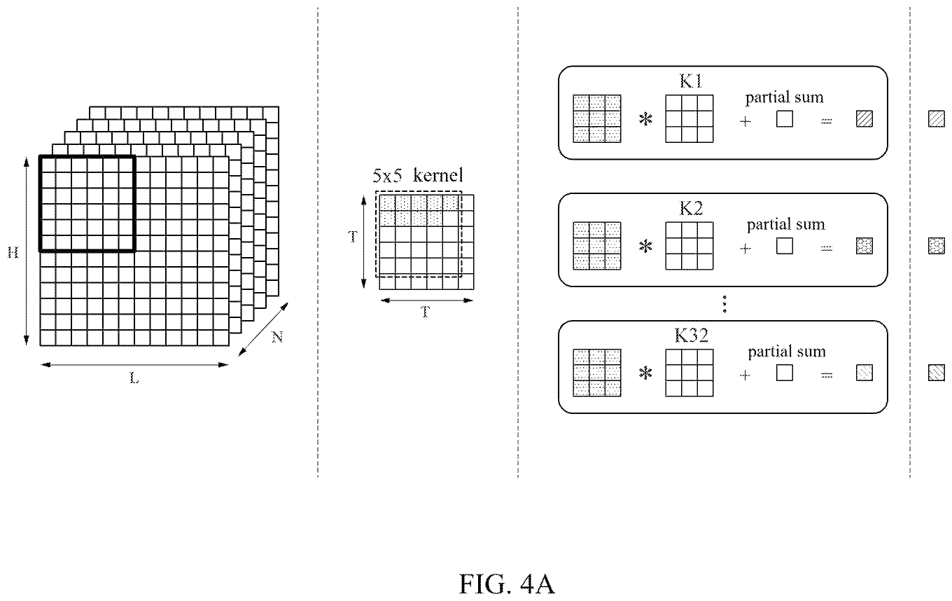

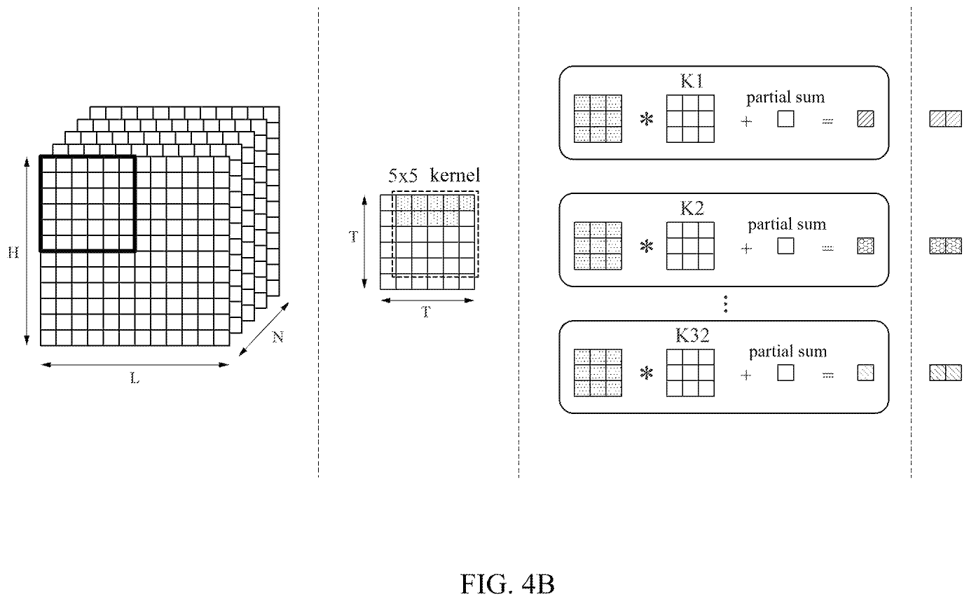

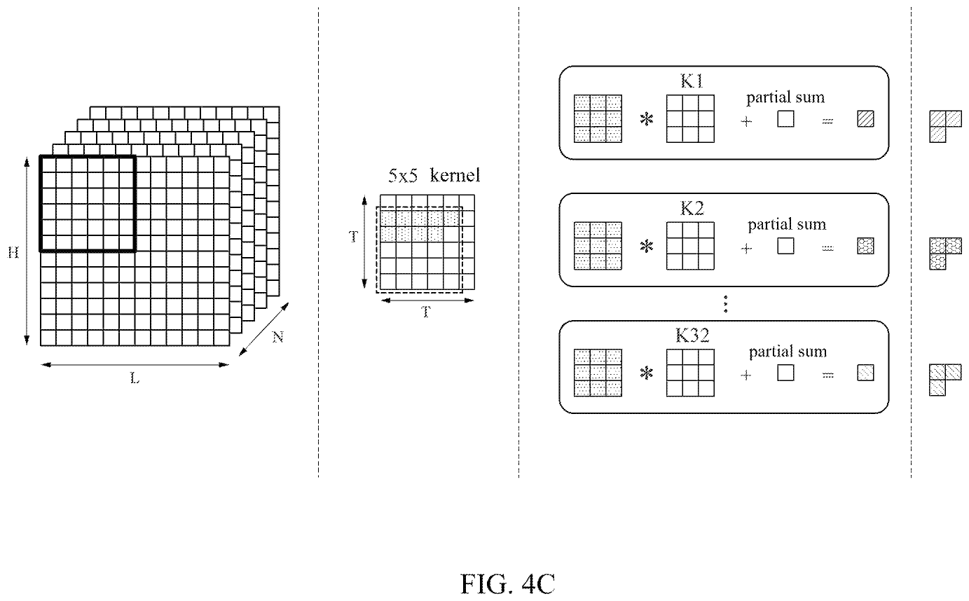

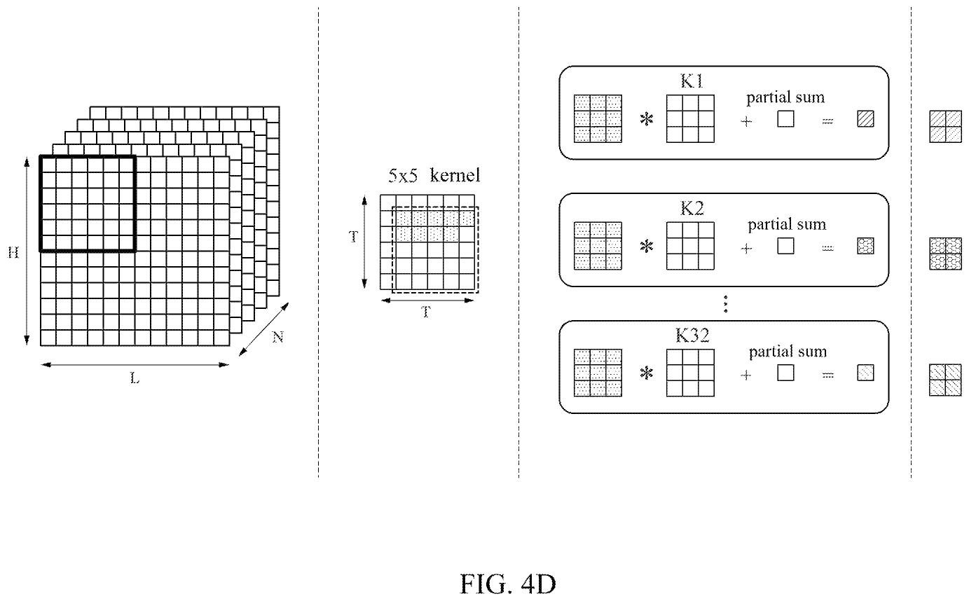

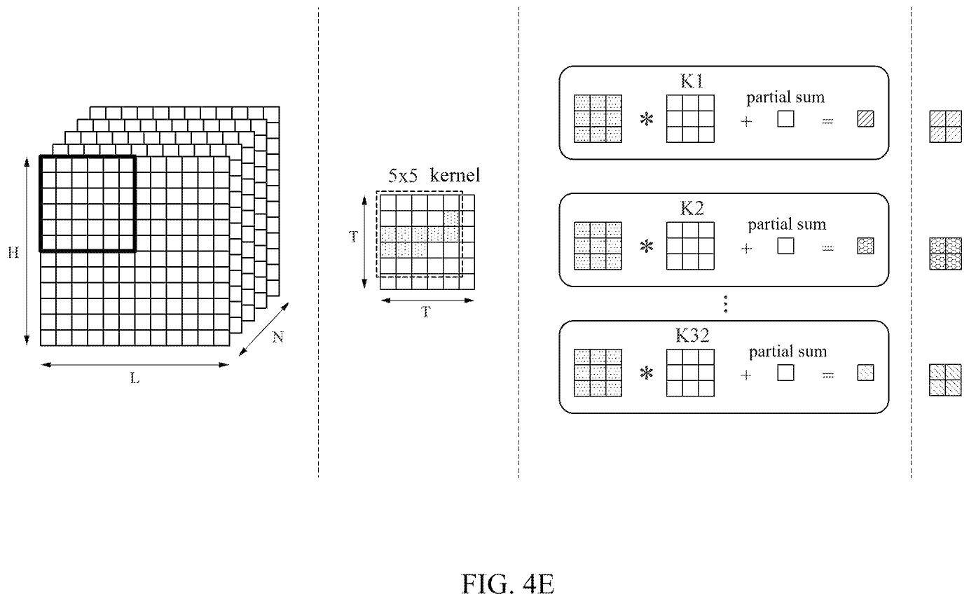

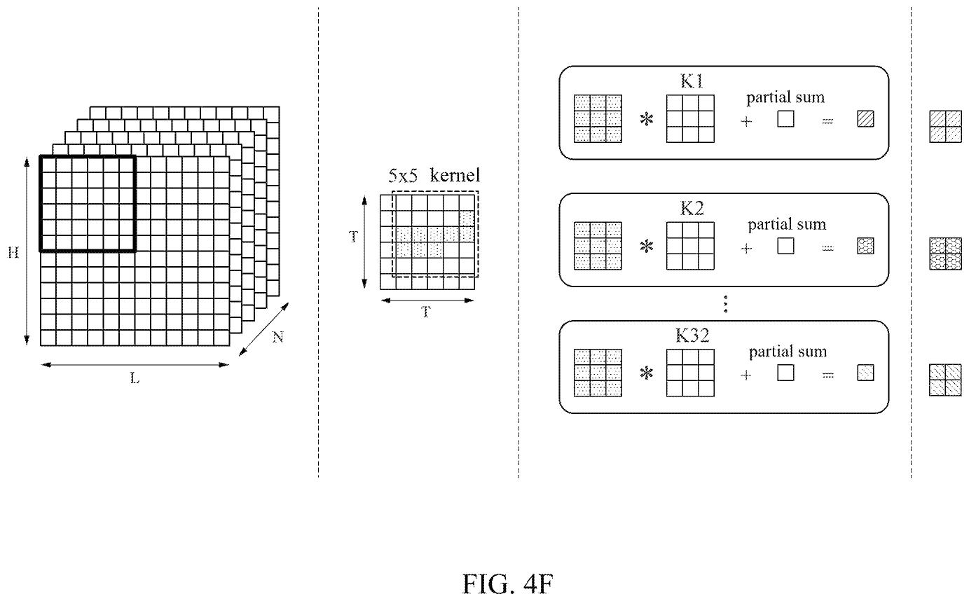

References are made to FIG. 4A to FIG. 4F. FIG. 4A to FIG. 4F illustrate schematic diagrams of steps of the execution method for convolution computation 200 according to a second embodiment of the present disclosure. In this embodiment, the size of the kernel is 5×5. For ease of illustration, T is 6 shown in this example, but it should actually be 52.

As shown in FIG. 4A, similarly, the data of the input image of each channel is divided into multiple tiles according to the size of the feature tile. For the first tile of the input image of each channel, since the size of the kernel is 5×5, there are 25 mapped data from Iⱼ(p, q) to Iⱼ((p+4), (q+4)), wherein 1≤p≤(T−4) and 1≤q≤(T−4). It should be noted that in this embodiment, the size of the kernel is 5×5, and thus each of the kernels includes 25 weights W0-W24. However, in this embodiment, since the number of multiply-accumulate units (e.g., Y, and Y=9) included in each of the processing units 111 is less than the number of weights, it is unable to perform the multiply-accumulate operation on these 25 data at the same time. In one embodiment, there are nine mapped data selected from these 25 mapped data for calculation.

Accordingly, in this embodiment, as shown in FIG. 4A, the multiply-accumulate operation is performed on the consecutive mapped data from the first to the Y-th among the 25 mapped data (i.e., the first to the ninth mapped data in this example). After the multiply-accumulate operation is complete, the kernel is shifted so that p is added by 1 (i.e., the kernel is shifted right by one data unit), as shown in FIG. 4B, and the multiply-accumulate operation is performed on the changed consecutive mapped data from the first to the Y-th among the 25 mapped data until p=(T−4).

It should be noted that the nine selected data in FIG. 4A correspond to the weights W0-W8, respectively. However, if the operation is performed on the next nine data (as shown in FIG. 4E), the weights corresponding to the next nine data are W9-W17. It means that these weights must be re-accessed from the off-chip memory 190 or the second buffer 193, thereby resulting in a long waiting time for data access and reducing the performance. Therefore, in this embodiment, in the condition that the size of the kernel is larger than the number of multiply-accumulate units of the processing unit, the kernel is shifted after each time one of the multiply-accumulate operations is complete, rather than after the multiply-accumulate operations performed on all of the data mapped by the kernel are complete, thereby avoiding the waiting time for accessing new weights.

Next, as shown in FIG. 4C, when p=(T−4) and q=K, after the multiply-accumulate operation performed on the mapped data is complete, the kernel is shifted so that P=1 and q=(K+1) (i.e., the kernel is shifted down by one data unit and returns to the first column), and the multiply-accumulate operation performed on the changed consecutive mapped data from the first to the Y-th among the 25 mapped data, wherein 1≤K≤(T−4).

When p=(T−4) and q=(T−4), after the multiply-accumulate operation performed on the mapped data is complete, the kernel is shifted so that p=1 and q=1 in the condition of (25−Y)>Y Each time the kernel is shifted, the multiply-accumulate operation is performed on the changed consecutive mapped data from the (Y+1)-th to the 2Y-th among the 25 mapped data. Specifically, when the number of the remaining weights (i.e., (25−Y)) in the kernel, which are not calculated yet, is greater than the number of multiply-accumulate units (Y), the operation for the remaining mapped data still cannot be finished at one time. Therefore, at this time, it returns to perform the multiply-accumulate operation on the consecutive mapped data from the (Y+1)-th to the 2Y-th among the original 25 mapped data (i.e., the 10th to the 18th mapped data in this example), and the kernel is shifted according to the above rules.

When p=(T−4) and q=(T−4), after the multiply-accumulate operation performed on the mapped data is complete, the kernel is shifted so that p=1 and q=1 in the condition of (25−Y)<Y Each time the kernel is shifted, the multiply-accumulate operation is performed on the changed consecutive mapped data from the (Y+1)-th to the 25th among the 25 mapped data and Z default data from the first to the Z-th, wherein Z=(2Y−25). Specifically, when the number of the remaining weights (i.e., (25−Y)) in the kernel, which are not calculated yet, has been less than the number of multiply-accumulate units (Y), the operation for the remaining mapped data can be finished at one time. However, it is possible that the number of multiply-accumulate units is greater than the number of remaining weights. In order to avoid that a part of the multiply-accumulate units is not utilized, the default data may be provided to said part of the multiply-accumulate units in this condition. The number of the default data is Z, and the value thereof is defaulted to zero, wherein Z is equal to the number of multiply-accumulate units (Y) minus the number of weights which are not calculated.

Similarly, after the convolution computation performed on all of the data of the first tile of the input image of the first channel, i.e., the convolution computation performed in the first tile is complete, the convolution computation is performed sequentially on the first tile of the input image of the second channel according to the above rules until the convolution computation performed on the first tile of the input image of the N-th channel is complete. After the convolution computations performed on the first tile of the input image of the N channels are complete, then it returns to the input image of the first channel, and the convolution computation is performed sequentially on the second tile of the input image of the first channel according to the above rules until the convolution computations performed on all of the tiles of the input image of the N channels are complete.

Briefly, in the condition that the size of the kernel is greater than the number of multiply-accumulate units included in each of the processing units 111, a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

In the above method, during the execution, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit is improved.

FIG. 3A to FIG. 3H illustrate a case of that the size of the kernel (i.e., the number of weights) is equal to the number of multiply-accumulate units included in each of processing units 111. FIG. 4A to FIG. 4F illustrate a case of that the size of the kernel is greater than the number of multiply-accumulate units included in each of the processing units 111. The following may focus on the case of that the size of the kernel is less than the number of multiply-accumulate units included in each of the processing units 111.

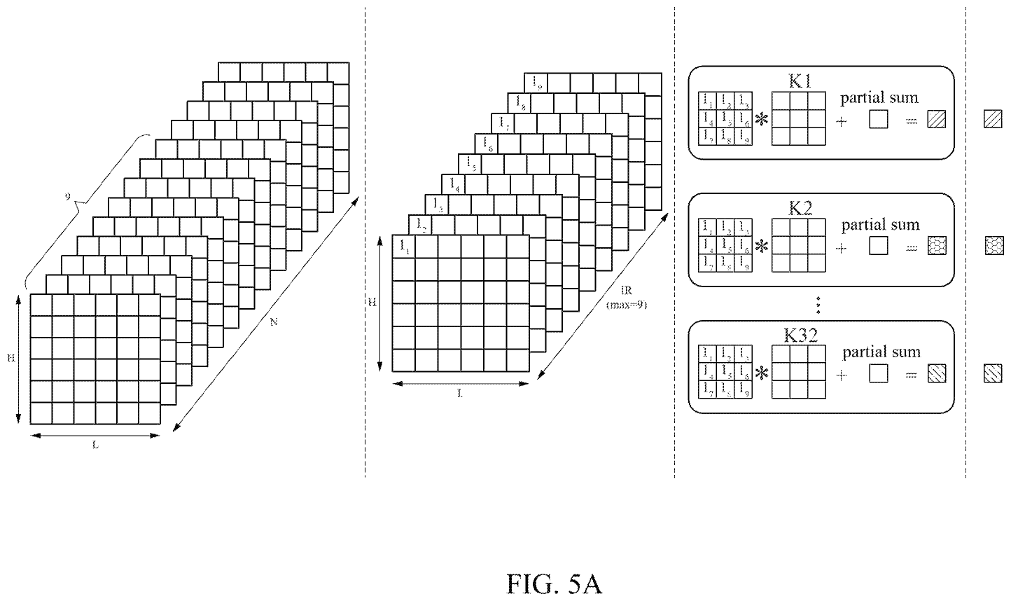

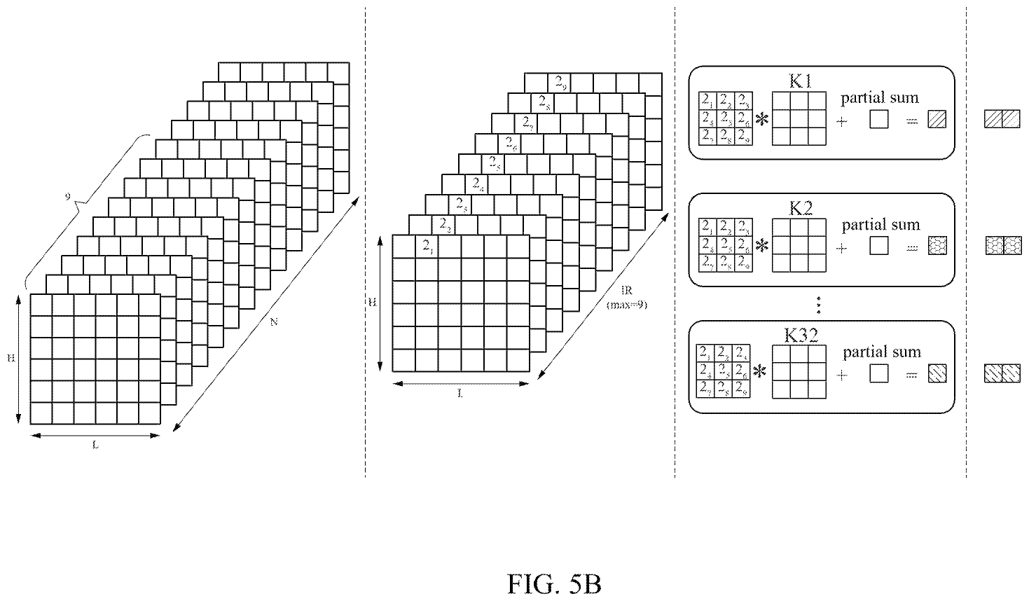

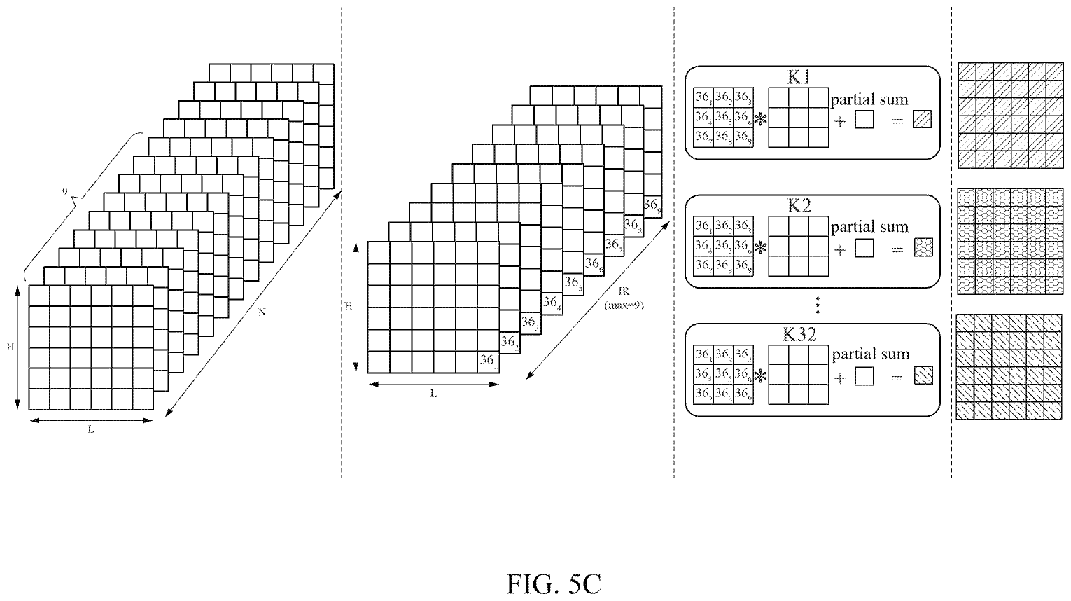

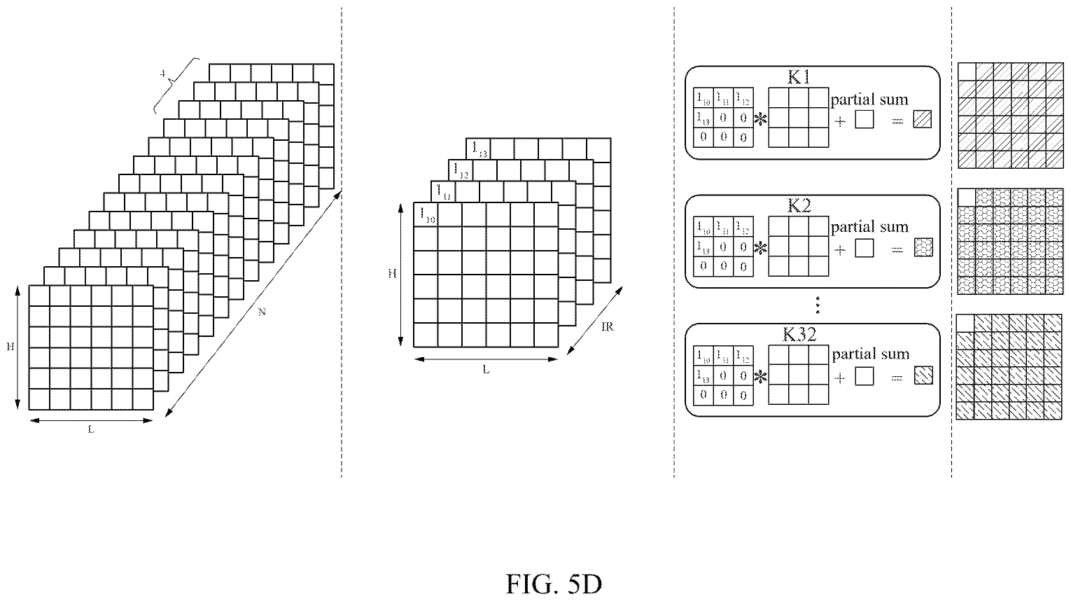

References are made to FIG. 5A to FIG. 5D. FIG. 5A to FIG. 5D illustrate schematic diagrams of steps of the execution method for convolution computation 200 according to a third embodiment of the present disclosure. In this embodiment, the size of the kernel is lxi.

As shown in FIG. 5A, since the kernel includes only one weight, a large number of multiply-accumulate units are not utilized if multiple multiply-accumulate units of the processing unit 111 perform the operation on the data mapped by the kernel according to the above method, which results in a great reduction of the performance. Therefore, in this embodiment, the mapped data for the multiply-accumulate operation are data, which are Iⱼ(p, q)-I_{Y}(p, q) at a same position of the input image from the first channel to the Y-th channel, wherein 1≤p≤T, 1≤q≤T, and Y is the number of the multiply-accumulate units included in each of the processing units 111. When p≠T, each time one of the multiply-accumulate operations performed on the Y data mapped by the kernel is complete, the kernel is shifted so that p is added by 1 until p=T. For example, in this embodiment, Y=9, the mapped data for the first operation are I₁(1,1)-I₉(1,1), the mapped data for the second operation are I₁(2,1)-I₉(2,1), and so on.

When p=T and q=K, after the multiply-accumulate operation performed on the Y mapped data, which are Iⱼ(T, K), I₍ⱼ₊₁₎(T, K), I₍ⱼ₊₂₎(T, K), . . . , I_{Y}(T, K), is complete, the kernel is shifted so that p=1 and q=(K+1), wherein 1 K (T−1).

When p=T and q=T, after the multiply-accumulate operation performed on the Y mapped data, which are Iⱼ(T, K), I₍ⱼ₊₁₎(T, K), I₍ⱼ₊₂₎(T, K), . . . , I_{Y}(T, K), is complete, the kernel is shifted so that p=1 and q=1 in the condition of (N−Y)>Y, and the mapped data for the multiply-accumulate operation are data, which are I_{(Y+1)}(p, q)-I_{2Y}(p, q) at a same position of the input image from the (Y+1)-th channel to the 2Y-th channel. In the condition that the number of the input image of the channels which are not calculated is still larger than the number of the multiply-accumulate units, since the operation for the data at the same position of the remaining input images still cannot be finished at one time, the multiply-accumulate operation continues to be performed on the data, which are I_{(Y+1)}(p, q)-I_{2Y}(p, q), at a same position of the input image from the (Y+1)-th channel to the 2Y-th channel in order.

On the other hand, in the condition of (N−Y)<Y (e.g., in this embodiment, N=13 and Y=9), since the number of the input image of the channels which are not calculated is less than the number of the multiply-accumulate units, the operation for the data at the same position of the remaining input images can be finished at one time. However, similar to the case of the kernel with the size of 5×5, the number of the remaining channels may be less than the number of the multiply-accumulate units in this case. In order to avoid that a part of the multiply-accumulate units is not utilized, the default data may be provided to said part of the multiply-accumulate units in this case. The number of the default data is F, and the value thereof is defaulted to zero, wherein F is equal to the number of multiply-accumulate units (e.g., Y) minus the number of channels which are not calculated (e.g., (N−Y)), for example, F=5 in this case.

In the above method, during the execution, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit is improved.

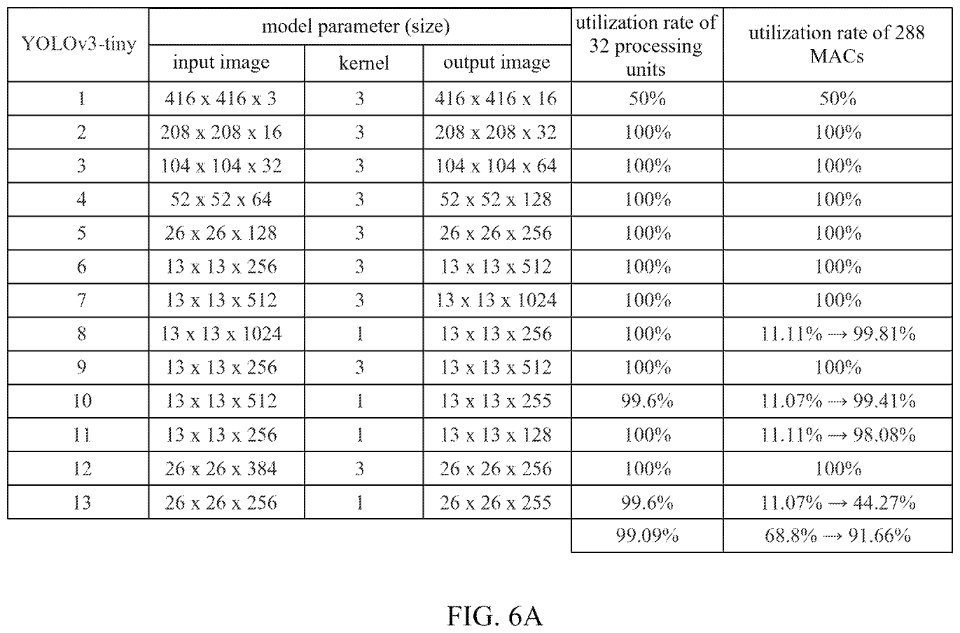

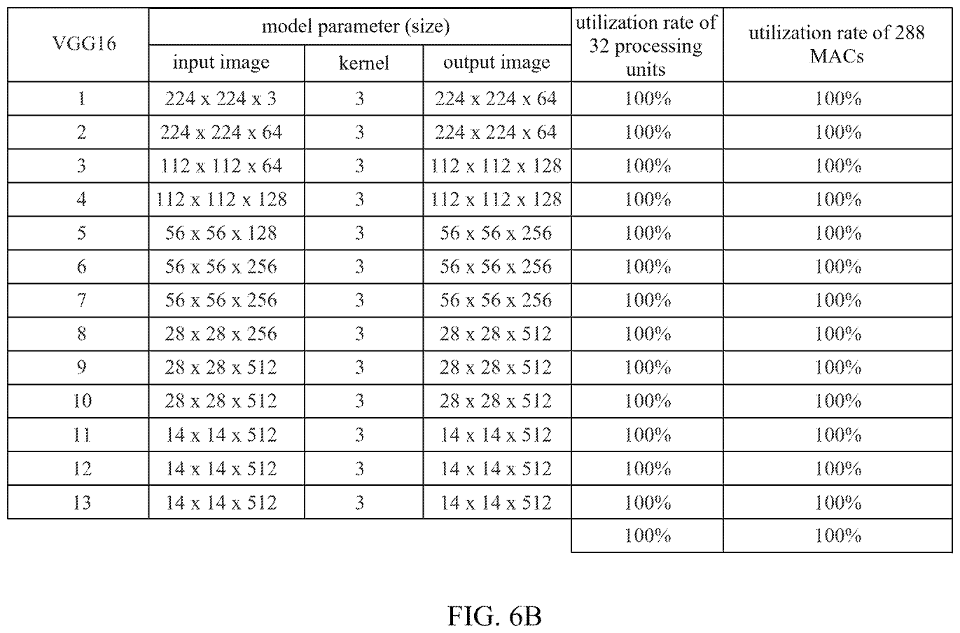

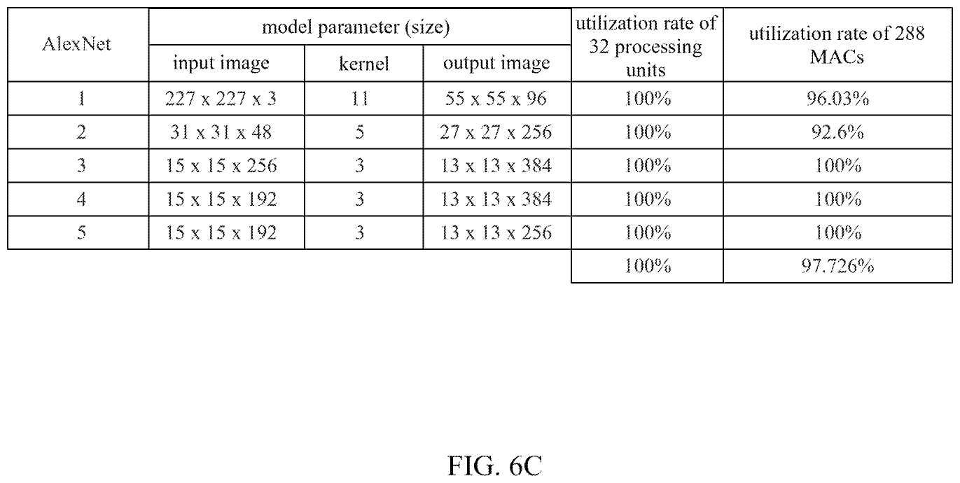

References are made to FIG. 6A to FIG. 6C. FIG. 6A illustrates an experimental result of performing the execution method for convolution computation 200 on YOLOV3-tiny according to some embodiments of the present disclosure. FIG. 6B illustrates an experimental result of performing the execution method 200 for convolution computation on VGG16 according to some embodiments of the present disclosure. FIG. 6C illustrates an experimental result of performing the execution method for convolution computation 200 on AlexNet according to some embodiments of the present disclosure. From FIG. 6B and FIG. 6C, it can be clearly seen that the size of kernel is 3×3 or larger (i.e., the number of weights is equal to or greater than the number of multiply-accumulate units included in each of the processing units), the utilization rates of the processing unit and multiply-accumulate unit using the convolution computation method 200 are almost 100%, and thus the utilization rate of the processor can be increased to almost the upper limit and can be used effectively. From FIG. 6A, it can be found that even the size of kernel is 1×1 (i.e., the number of weights is less than the number of the number of multiply-accumulate units included in each of the processing units), the utilization rate of multiply-accumulate units has increased from 11.11% to more than 98%, and the utilization rate has increased significantly.

To sum up, in the execution method for convolution computation 200 of the present disclosure, during the execution, the data of some input images, weight values, and output images are reused to avoid repeated access to the same data from off-chip memory or on-chip memory, so as to maximize the efficiency. Therefore, high utilization of multiply-accumulate units and reduction of time for accessing data from the off-chip memory can be achieved, such that the performance of the convolution computation unit is improved.

It will be appreciated by those skilled in the art that changes could be made to the embodiments described above without departing from the broad inventive concept thereof. It is understood, therefore, that present disclosure is not limited to the particular embodiments disclosed, but it is intended to cover modifications within the spirit and scope of the present disclosure as defined by the appended claims.

What is claimed is:

1. An execution method for convolution computation, which is executed by a convolution computation unit that comprises a plurality of processing units and a controller, wherein the execution method comprises steps of:
by the controller, dividing an input image of N channels into X tiles including a first tile to an X-th tile according to a feature tile with size of T×T, wherein each of the X tiles comprises T×T data, which are Iⱼ(1,1)-Iⱼ(T, T), wherein j is corresponding one of the channels and 1≤j≤N; and
by the processing units, sequentially performing convolution computations on the data in the first tile of the input image of the N channels to the X-th tile of the input image of the N channels, and storing the computation results as output data;
wherein the data in each of the tiles are mapped by a kernel with size of A×A, and multiply-accumulate operation is performed on the mapped data in each of the tiles, wherein each time one of the multiply-accumulate operations performed on the A×A data mapped by the kernel is complete, the kernel is shifted to change the mapped data in said tile, and multiply-accumulate operation is performed on the changed mapped data until the multiply-accumulate operations performed on all of the data in said tile are complete, thereby finishing the convolution computation of said tile, and all of the output data form an output image, wherein 1≤A≤T.

2. The execution method for convolution computation according to claim 1, in the condition of A=3, the mapped data in each of the tiles for the multiply-accumulate operations are Iⱼ(p, q), Iⱼ((p+1), q), Iⱼ((p+2), q), Iⱼ(p, (q+1)), Iⱼ((p+1), (q+1)), Iⱼ((p+2), (q+1)), Iⱼ(p, (q+2)), Iⱼ(p+1), (q+2)), Iⱼ((p+2), (q+2)), wherein 1≤p≤(T−2), 1≤q≤(T−2); wherein when p=1 and q=1, a first multiply-accumulate operation is performed.

3. The execution method for convolution computation according to claim 2, when p≠(T−2), each time one of the multiply-accumulate operations performed on the A×A data mapped by the kernel is complete, the kernel is shifted so that p is added by 1 until p=(T−2).

4. The execution method for convolution computation according to claim 3, when p=(T−2) and q=K, after the multiply-accumulate operation performed on the mapped data, which are Iⱼ((T−2), K), Iⱼ((T−1), K), Iⱼ(T, K), Iⱼ((T−2), (K+1)), Iⱼ((T−1), (K+1)), Iⱼ(T, (K+1)), Iⱼ((T−2), (K+2)), Iⱼ((T−1), (K+2)), Iⱼ(T, (K+2)), is complete, the kernel is shifted so that p=1 and q=(K+1), wherein 1≤K≤(T−2).

5. The execution method for convolution computation according to claim 4, when p=(T−2) and q=(T−2), after the multiply-accumulate operation performed on the mapped data, which are Iⱼ((T−2), (T−2)), Iⱼ((T−1), (T−2)), Iⱼ(T, (T−2)), Iⱼ((T−2), (T−1)), Iⱼ((T−1), (T−1)), Iⱼ(T, (T−1)), Iⱼ((T−2), T), Iⱼ((T−1), T), Iⱼ(T, T), is complete, the multiply-accumulate operations performed on all of the data in said tile are complete, and the kernel is not shifted.

6. The execution method for convolution computation according to claim 2, wherein a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

7. The execution method for convolution computation according to claim 1, wherein each of the processing units comprises Y multiply-accumulate units for performing the multiply-accumulate operation, in the condition of A=5 and Y<25, the mapped data of each of the tiles for the multiply-accumulate operations are twenty-five data Iⱼ(p, q)-Iⱼ((p+4), (q+4)), wherein 1≤p≤(T−4), 1≤q≤(T−4); when p≠(T−4), the multiply-accumulate operation is performed on the consecutive mapped data from the first to the Y-th among the twenty-five mapped data, wherein after the multiply-accumulate operation performed on the consecutive mapped data from the first to the Y-th are complete, the kernel is shifted so that p is added by 1, and the multiply-accumulate operation are performed on the changed consecutive mapped data from the first to the Y-th among the twenty-five mapped data until p=(T−4).

8. The execution method for convolution computation according to claim 7, when p=(T−4) and q=K, after the multiply-accumulate operation performed on the consecutive mapped data from the first to the Y-th among the twenty-five mapped data are complete, the kernel is shifted so that p=1 and q=(K+1), and the multiply-accumulate operation are performed on the changed consecutive mapped data from the first to the Y-th among the twenty-five mapped data, wherein 1≤K≤(T−4).

9. The execution method for convolution computation according to claim 8, when p=(T−4) and q=(T−4), after the multiply-accumulate operation performed on the consecutive mapped data from the first to the Y-th among the twenty-five mapped data are complete, the kernel is shifted so that p=1 and q=1 in the condition of (25−Y)>Y, and each time the kernel is shifted, the multiply-accumulate operation is performed on the changed consecutive mapped data from the (Y+1)-th to the 2Y-th among the twenty-five mapped data.

10. The execution method for convolution computation according to claim 9, when p=(T−4) and q=(T−4), after the multiply-accumulate operation performed on the consecutive mapped data from the first to the Y-th among the twenty-five mapped data are complete, the kernel is shifted so that p=1 and q=1 in the condition of (25−Y)<Y, and each time the kernel is shifted, the multiply-accumulate operation is performed on the changed consecutive mapped data from the (Y+1)-th to the 25th among the twenty-five mapped data and Z default data from the first to the Z-th, wherein Z=(2Y−25).

11. The execution method for convolution computation according to claim 7, wherein a sequence of performing convolution computations is that the convolution computation is performed on the W-th tile of the input image of the first channel to the N-th channel sequentially, and the convolution computation is not performed on the (W+1)-th tile of the input image of the first channel to the N-th channel sequentially until the convolution computations performed on the W-th tiles of the input image of the N channels are complete, wherein 1≤W≤X.

12. The execution method for convolution computation according to claim 1, wherein each of the processing units comprises Y multiply-accumulate units for performing the multiply-accumulate operation, in the condition of A=1 and 1<Y<N, the mapped data for the multiply-accumulate operation are data, which are Iⱼ(p, q)-I_{Y}(p, q) at a same position of the input image from the first channel to the Y-th channel, wherein 1≤p≤T, 1≤q≤T.

13. The execution method for convolution computation according to claim 12, when p≠T, each time one of the multiply-accumulate operations performed on the Y data mapped by the kernel is complete, the kernel is shifted so that p is added by 1 until p=T.

14. The execution method for convolution computation according to claim 13, when p=T and q=K, after the multiply-accumulate operation performed on the Y mapped data, which are Iⱼ(T, K)-I_{Y}(T, K), is complete, the kernel is shifted so that p=1 and q=(K+1), wherein 1≤K≤(T−1).

15. The execution method for convolution computation according to claim 14, when p=T and q=T, after the multiply-accumulate operation performed on the Y mapped data, which are Iⱼ(T, T)-I_{Y}(T, T), is complete, the kernel is shifted so that p=1 and q=1 in the condition of (N−Y)>Y, and the mapped data for the multiply-accumulate operation are data, which are I_{(Y+1)} (p, q)-I_{2Y}(p, q) at a same position of the input image from the (Y+1)-th channel to the 2Y-th channel.

16. The execution method for convolution computation according to claim 14, when p=T and q=T, after the multiply-accumulate operation performed on the Y mapped data, which are Iⱼ(T, T)-I_{Y}(T, T), is complete, the kernel is shifted so that p=1 and q=1 in the condition of (N−Y)<Y, and the mapped data for the multiply-accumulate operation are data, which are I_{(Y+1)}(p, q)-I_{N}(p, q) at a same position of the input image from the (Y+1)-th channel to the N-th channel and F default data from the first to the F-th, wherein F=(2Y−N).

17. The execution method for convolution computation according to claim 1, wherein each time one of the multiply-accumulate operations performed on the data mapped by the kernel is complete, the completed multiply-accumulate operation result is added by a partial sum to obtain the computation result, and a value of the partial sum is replaced by a value of the computation result.
